(19) United States
(12) Patent Application Publication
(10) Pub. No.: US 2003/0029861 A1
(43) Pub. Date: Feb. 13, 2003

(54) Heating device, in particular for a sensor element for the analysis of gases

(76) Inventors: Hans-Jorg Renz, Leinfelden-Echterdingen (DE); Lothar Diehl, Stuttgart (DE)

Correspondence Address: Richard L Mayer, Kenyon & Kenyon, One Broadway, New York, NY, 10004, US

(21) Appl. No.: 10/111,488

(22) PCT Filed: Aug. 7, 2001
(86) PCT No.: PCT/DE01/03020

(30) Foreign Application Priority Data
Aug. 26, 2000 (DE) 100 42 000.1

(51) Int. Cl. B60L 1/02

(52) U.S. Cl. 219/543; 219/202

(57) ABSTRACT

A heating device is proposed, particularly for a sensor element for the analysis of exhaust gases of internal combustion engines. For this purpose, the heating device has a particularly meander-shaped heating conductor (11) proceeding on a substrate (10), as well as at least one heat-conducting element (12) positioned in one vicinity of the heating conductor (11) and electrically insulated from heating conductor (11).

The present invention relates to a heating device, especially for a sensor element for the analysis of exhaust gases of internal combustion engines, according to the species of the main claim.

### BACKGROUND INFORMATION

During the production of planar gas sensors (“lambda probes”), it is known that one should heat them with the aid of a heating device that is integrated into a multi-layer ceramic laminate structure. Thus, Application DE 199 06 908 A1 described constructing a heating device, designed in a meandering pattern between two ceramic layers in the form of platinum printed circuit traces, which are located in the hot part of the gas sensor, i.e. the part in which are also located the measuring and reference electrodes, and which is exposed to the gas to be analyzed.

It was the object of the present invention to improve known heating devices, such as the ones used in gas sensors, with regard to shortening heating time and having them supply heat as uniformly as possible.

### SUMMARY OF THE INVENTION

The heating device according to the present invention has the advantage over the related art that supplying clearly more uniform heat to electrodes and/or electrolyte layers above it is achieved by the heating device. The heating device according to the present invention also results in a clearly shortened heating time, because of improved heat transfer and improved heat supply to neighboring layers. Finally, the uniformity of heat radiation achieved also leads to a lessening of the danger of crack formation, for example, in a gas sensor having such a heating device.

The explained advantages of the heating device according to the present invention are based in substantial part on taking advantage of the so-called black-body radiation effect, i.e. the arrangement of additional heat-conducting elements, such as flat metal strips in the surroundings of the heating conductor, which are electrically insulated from it, to be sure, but are in contact with the heating conductors in a heat-conducting manner, and which by heat radiation therefore have the effect of supplying uniform and rapid heat to the entire surface furnished with the heating device or to neighboring surfaces. Incidentally, the overall available radiation surface of the heating device is also increased by the heat-conducting elements provided.

Advantageous further refinements of the present invention result from the measures indicated in the dependent claims.

Thus, it is especially advantageous if the heat-conducting elements provided are flat metal strips made of the same material as the meander-shaped heating conductors, and, in particular are designed in the form of flat platinum strips. It is further advantageous if as many flat metal strips as possible, distributed between the meander structures of the heating conductor, are provided, it having to be always guaranteed, however, that no short circuits develop between the heating conductors and the additional flat metal strips applied in their surroundings.

### BRIEF DESCRIPTION OF THE DRAWINGS

The invention is explained in greater detail in the following description with reference to the drawings.

FIG. 1 shows a heating device known from the related art, as is used in gas sensors,

FIG. 2 shows a modified heating device according to the present invention.

### EXEMPLARY EMBODIMENTS

The explained exemplary embodiment starts from a gas sensor (“lambda probe”) having a plurality of ceramic layers and at least one measuring electrode exposed to a gas to be analyzed, as well as at least one reference electrode, as has already been proposed, for example, in Application DE 199 06 908 A1.

From this it is further known that one can produce platinum printed circuit traces on a planar zirconium oxide substrate, which are designed in a meander pattern in the hot region of the gas sensor. On the substrate having the heating conductors there is also a further insulating layer, such as aluminum oxide. Finally, it is known from this that one can produce the heating conductors running on the substrate by printing on a platinum-containing paste and by subsequent sintering to platinum, so that planar platinum printed circuit traces are created meander-shaped in the hot region of the sensor.

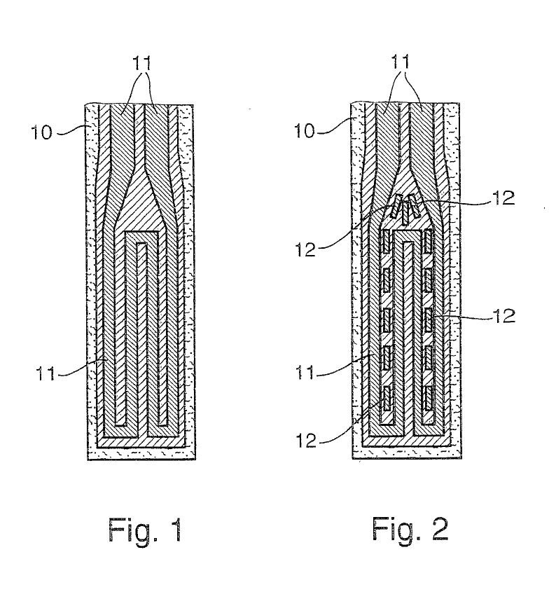

FIG. 1 shows such a heating device known from the related art, planar platinum printed circuit traces having been produced as heating conductors 11 on a substrate 10 made of zirconium dioxide. These heating conductors 11 further have a meander-shaped structure from place to place, and are finally integrated into the insulating layer, not shown.

FIG. 2 shows, as exemplary embodiment of the present invention, a modification of FIG. 1, additional flat metal strips 12, electrically insulated from heating conductor 11, being positioned between the meander-shaped structures of heating conductors 11. These flat metal strips 12 are also made of platinum in the explained example, and were created simultaneously with the printing of heating conductors 11 on substrate 10. According to FIG. 2, it is also shown that preferably a plurality of such flat metal strips 12 is provided, these flat metal strips 12 being always so arranged that no short circuits occur between the individual meanders of heating conductor 11.

With regard to further details, known per se, on the heating device according to FIG. 1 or FIG. 2, as well as on the gas sensor produced with it, we refer to Application DE 199 06 908 A1.

What is claimed is:

1. A heating device, especially for a sensor element for the analysis of exhaust gases of internal combustion engines, having a heating conductor (11) running on a substrate (10),
wherein in one vicinity of the heating conductor (11) at least one heat-conducting element (12) is positioned, electrically insulated from heating conductor (11).

2. The heating device as recited in claim 1,
wherein the heat-conducting element (12) is designed as a flat metal strip.

3. The heating device as recited in claim 2,
wherein a plurality of flat metal strips is provided which are assigned to one vicinity of a heating conductor (11) designed to have a meander-shape, and electrically insulated from it.

4. The heating device as recited in claim 2 or 3,
wherein the flat metal strips include at least one well heat-conducting metal.

5. The heating device as recited in claim 4,
wherein the metal is platinum or a platinum alloy.

6. The heating device as recited in claim 1,
wherein the heating conductor (11) is designed in the form of particularly meander-shaped platinum printed circuit traces running on a ceramic substrate (10).
